(19) United States
(12) Patent Application Publication
(10) Pub. No.: US 2009/0155414 A1
(43) Pub. Date: Jun. 18, 2009

(54) ENHANCED ETHANOL FERMENTATION YIELDS BY REMOVAL OF SUGARS VIA BACKSET MOLASSES

(76) Inventors: Charles A. Abbas, Champaign, IL (US); James Joseph Foster, Decatur, IL (US); Thomas V. Gottemoller, Mount Zion, IL (US)

Correspondence Address: BUCHANAN INGERSOLL & ROONEY PC;(ARCHER DANIELS MIDLAND COMPANY), 301 GRANT STREET, 20TH FLOOR, PITTSBURGH, PA, 15219, US

(21) Appl. No.: 12/332,865

(22) Filed: Dec. 11, 2008

Related U.S. Application Data
(60) Provisional application No. 61/007,488, filed on Dec. 13, 2007.

(51) Int. Cl. A23K 1/00

(52) U.S. Cl. 426/48; 426/62

(57) ABSTRACT

Embodiments of the invention relate to methods for increasing the rate of production in an ethanol fermentation by increased carbohydrate feeding and diversion of backset from recycling as process water in the fermentation. Novel products derived from the diverted backset are also provided.

### CROSS-REFERENCE TO RELATED APPLICATION

This application claims priority to pending U.S. Provisional Patent Application Ser. No. 61/007,488, filed on Dec. 13, 2007. U.S. Provisional Patent Application Ser. No. 61/007,488 is incorporated by reference into this application as if fully rewritten herein.

### BACKGROUND OF THE INVENTION

The following includes information that may be useful in understanding the present teachings. It is not an admission that any of the information provided herein is prior art, or material, to the presently described or claimed subject matter, or that any publication or document that is specifically or implicitly referenced is prior art.

### 1. FIELD OF THE INVENTION

The present teachings relate to, but are not limited to, the field of ethanol fermentation. Embodiments relate, for example, to methods for increasing the rate of production in an ethanol fermentation by increased carbohydrate feeding and diversion of backset from recycling as process water in the fermentation. Other embodiments relate to creation of a novel product from the diverted backset. This product may be suitable for a number of applications, including but not limited to the preparation of one or more livestock feed supplements.

### 2. BACKGROUND OF THE ART

Industrial ethanol fermentations typically begin by mixing a suitable carbohydrate source with other nutrients in water. Although corn is the most common carbohydrate source for ethanol production in the United States, other sources that can be used include oats, wheat, barley, rice, sugar cane, sugar beets, sorghum (milo), cassava, and soft and hard woods. That mixture is inoculated with a fermenting microbe, such as an industrial strain of brewer's yeast. Typical processes for production of ethanol include the dry grind process (FIG. 1) and the wet grind process (FIG. 2).

Management of the water used in the microbe/water/carbohydrate mixture is an important yet often overlooked aspect of ethanol plant operation and management. Proper management can contribute to increased profitability of a plant and efficient day-to-day facility operation.

Water used in industrial ethanol production can come from a number of sources. These sources can include, but are not limited to, condensate water, filtered mill water, fresh water, treated water and backset or the thin stillage liquid fraction recovered from backset after solid removal. Backset, also known as ethanol still bottoms, is the fermentation stream leaving the distillation column after the ethanol has been removed. The backset includes, but is not limited to, proteins, carbohydrates, and yeast.

Depending on the particulars of the ethanol plant, up to 75% of the backset stream is evaporated and added to other ethanol co-products to produce Corn Gluten Feed (CGF) as dried pellets or to produce Distiller's Dry Grains with Solubles (DDGS). The remaining backset is recycled to provide process water for the fermentation. This recycling is often important to the overall water balance of the plant, because it reduces the amount of fresh water that has to be added to the process. Fresh water is expensive, and it has to be extensively treated prior to entering the process.

The use of backset recycling is a limiting factor in ethanol production. In a batch, fed-batch, or continuous cascade ethanol production process, the rate of ethanol production is highest at or near the beginning of the fermentation. The rate then declines significantly as fermentation progresses. The high rate at the beginning is proportional to a number of factors. These factors include glucose concentration or the availability of other nutrients such as nitrogen, phosphate, vitamins, and divalent cations; viable yeast counts; and byproduct concentrations.

Although higher concentrations of ethanol may be possible in the later stages of fermentation, aggressive feeding by addition of carbohydrates is not used, at least in part due to the high residual sugars that may accumulate in the backset. High residual sugar in the backset also significantly impacts drying operations (for the production of DDGS) and contributes to increased Maillard reaction (browning) of sugars with free amino acid groups present in proteins.

High sugars in feed byproducts also contribute to reduced ethanol yield per bushel of corn in dry-grind ethanol plants or reduced yield from liquefied starch derived from corn in wet-mill ethanol plants. Typically, sugar concentration in backset must be less than 1 gm/100 ml. At higher levels the evaporated backset will contribute to higher than acceptable levels of simple sugars in CGF or DDGS feed. High residual sugar in feed can support microbial growth on the feed. This degrades the quality of the material and may generate sufficient heat to cause a spontaneous fire during storage or transport.

In addition to the limitations caused by the possible introduction of high residual sugar levels, ethanol production operations are also hindered by the need to completely (or nearly completely) dry the backset used in production of CGF or DDGS. Drying capacity and dryer efficiency are significant barriers to ethanol plant expansion and frequently cited as the causes of non-environmental compliance with VOC (volatile organic compounds) emissions. Reducing or eliminating the volumes of fibers and streams that are dried can allow for plant expansion and insure plant operations comply with EPA VOC limits. Because increased sugar content in the backset can increase the cost of drying the backset to make DDGS, ethanol fermentation is often optimized to obtain low residual sugar in the backset.

### BRIEF SUMMARY OF THE INVENTION

We have found that the rate of ethanol production for a facility may be significantly increased by not requiring fermentation to run until the sugar content of the fermentation mixture is less than 1 g/100 ml of the mixture. Backset containing high residual sugars (greater than 1 g/100 ml) is not incorporated into existing byproducts or recycled as part of the process water; instead it may be concentrated into a viscous liquid that we call “distillers' molasses.” This allows fermentations to be run with more aggressive carbohydrate feeding than is customary, and allows fermentation cycles to be shorter.

Distillers' molasses has a number of potential uses that may take advantage of the high level of residual sugars in the backset. For example, it may be used as an alternative to cane molasses or other molasses in animal feed.

### BRIEF DESCRIPTION OF THE FIGURES

FIG. 1 depicts a typical dry grind corn milling process for the production of ethanol. (Rausch, K. D. & Belyea, R. L., “Co-products from Bioprocessing of Corn” 2005 ASAE International Meeting, Paper No. 057041 (hereinafter “Rausch”)).

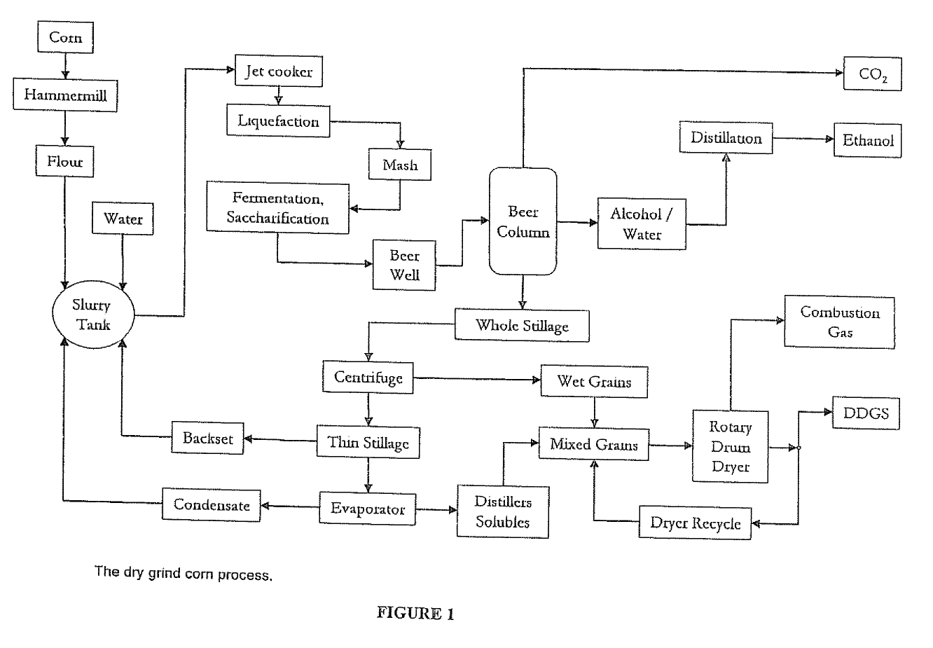

FIG. 2 depicts a typical corn wet milling process for the production of ethanol. (Rausch).

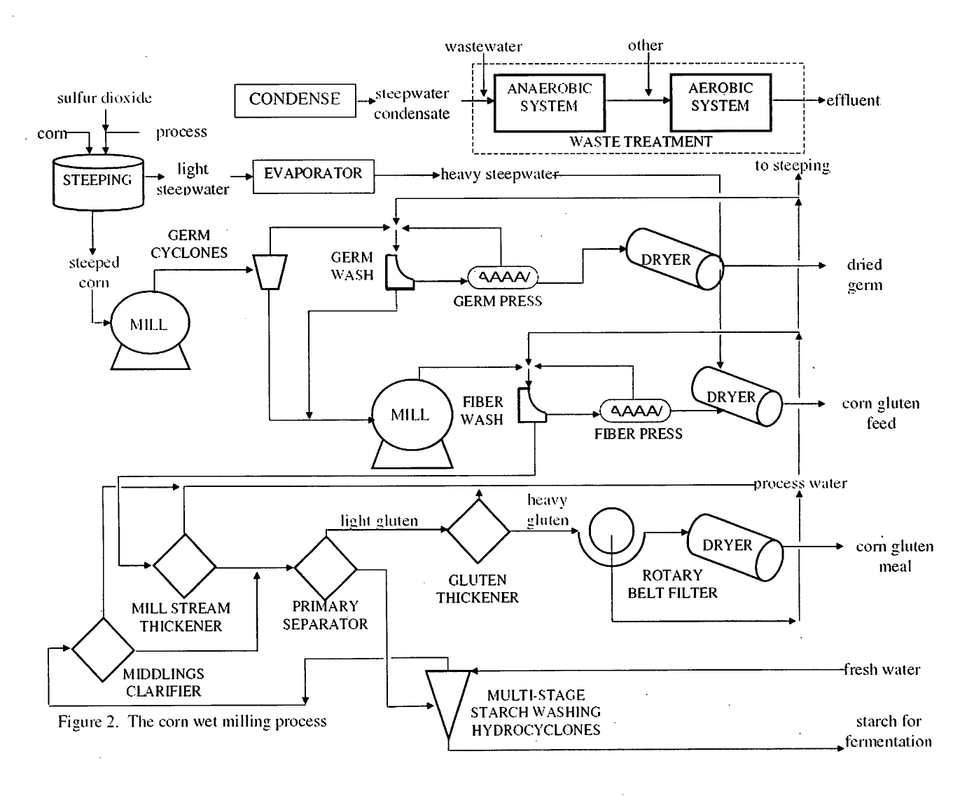

FIG. 3 depicts a comparison of dry mill and wet mill corn processes for ethanol production.

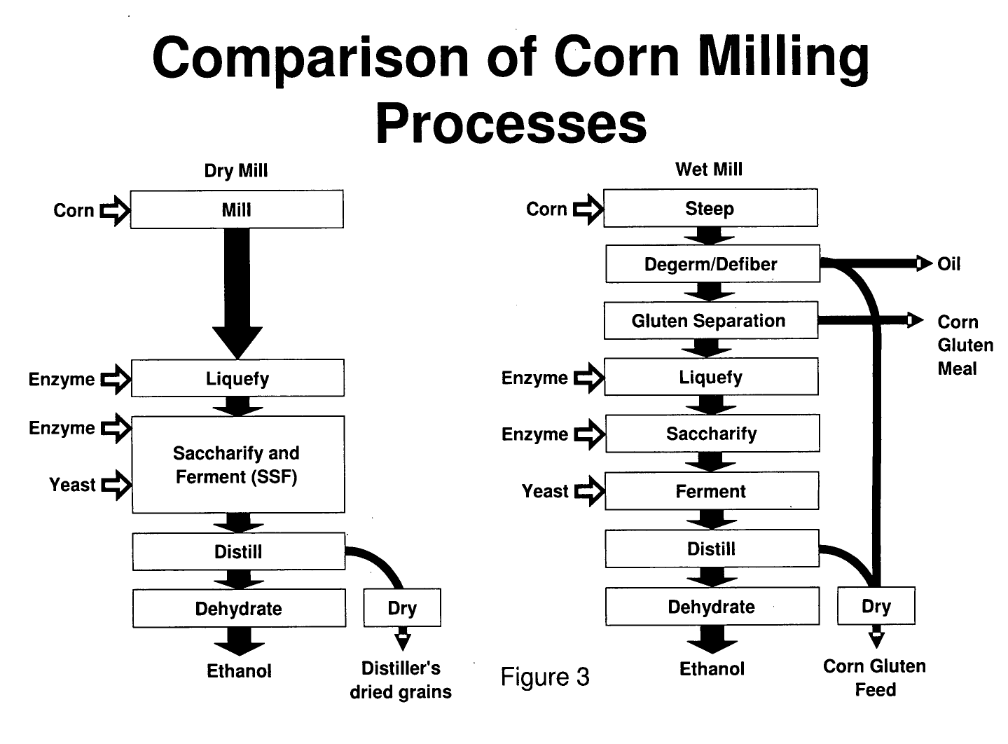

### DETAILED DESCRIPTION OF THE INVENTION

The present teaching describes several different features and aspects of the invention with reference to various exemplary embodiments. It is understood, however, that the invention embraces numerous alternative embodiments, which may be accomplished by combining any of the different features and aspects described herein in any combination that one of ordinary skill in the art would find useful.

Processing methods and products as described herein may offer many advantages over the prior art. Of course, the scope of the invention is defined by the claims, and whether an embodiment is within that scope should not be limited by whether the method provides one or more of these advantages.

We have found that creation of a distillers' molasses product from ethanol production backset allows higher rates of carbohydrate feeding, resulting in an increased rate of ethanol production and production of a desirable product containing the high levels of residual sugars that result. Higher acceptable residual sugars in backset can facilitate aggressive feeding, increased pumping rate during fermentation, and earlier termination of the fermentation, which maximizes yeast ethanol productivity. This is a departure from the prior art, which focuses on achieving high ethanol yields per bushel of raw material by achieving the highest possible concentration of ethanol in the fermentation vessel, regardless of the prolonged fermentation time necessary to obtain them.

TABLE 1
Wet mill Backset Molasses

| | | |
|---|---|---|
| % DS | 50 | |
| pH | 3.1 to 3.7 | |
| % Protein | 14.61 | gm/100 ml (as-is) |
| DP3+ | 6.94 | gm/100 ml (as-is) |
| DP2 | 4.11 | gm/100 ml (as-is) |
| Glucose | 0.53 | gm/100 ml (as-is) |

Concentration of the backset to form distillers' molasses is made more efficient by removal of yeast and other suspended solids prior to evaporation. A number of different methods for this removal may be used, including but not limited to centrifugation (for example, by decanting centrifuge), filtering, flocculation and screening. Removal of these suspended solids eases operation in the evaporators and reduces fouling of equipment through the deposition of suspended solids and salts. The yeast that is recovered by filtration from the backset may be used as a high-protein food source for animals.

Optionally, the nutritional value of the distillers' molasses may be increased by treatment and addition of fiber solubles obtained from the ethanol production process. For example, the corn fiber stream derived from a corn wet mill, or the hull fraction from a corn dry grind process may be subjected to a thermochemical and/or enzymatic treatment to solubilize the fiber. The solubilized fiber will include pentose sugars, including but not limited to D-xylose and L-arabinose and their oligosaccharides.

The solubilized fiber fraction can be mixed with the high-sugar backset prior to partial evaporation to form the distillers' molasses. This can enhance the quality of the distillers' molasses, because the sugars and oligomers have been known and used for their probiotic properties that enhance the resulting feed.

Concentration of the thin stillage to distillers' molasses does not require the level of evaporation used to create syrup or DDGS. Therefore, use of this process decreases the amount of energy necessary to process the ethanol byproducts. Although no particular decrease in energy usage is required (unless claimed), energy savings of up to 30% may be achieved over creation of conventional fermentation byproducts. Furthermore, reduction of drying can reduce the emission of volatile organic compounds (VOCs), rendering the ethanol production process more environmentally friendly.

Properties of the distillers' molasses will vary within certain parameters based on a number of conditions, including the type of originating fermentation feedstock and the identity of the fermentation ingredients. Typically, up to between 70% to 80% of the backset will be evaporated, resulting in a mixture that is about 60% to 80% solids by weight. Solids content of the distillers' molasses may be as shown in TABLE 1, above.

The distillers' molasses may be added to existing ruminant and non-ruminant feed to provide increased energy, protein, and palatability. An exemplary dosage is between 2% and 5%. The distillers' molasses will typically be added to the feed at the time of feeding, rather than being mixed and stored prior to feeding. Because of the protein content of the distillers' molasses, it will be superior in many respects as a feed to cane molasses. High stability of the distillers' molasses will make microbial growth in the molasses difficult, increasing the time that the distillers' molasses may be stored prior to feeding.

### Example 1

Example 1 reports a standard batch-fed ethanol production process, which does not use the high residual sugar fermentation method described herein and does not produce the distillers' molasses. In a typical prior art continuous wet milling ethanol fermentation, about 25 to 30% of the volume at about 45 to 50% solids is starch in a gelatinized slurry that have been treated with alpha amylase enzyme to reduce the viscosity. Backset, which is about 5% solids, is added to the corn steep liquor, which is diluted from between 7 to 11% solids to 3 to 6% solids. About 25 to 35% (by volume) of the backset produced by the fermentation is used as the diluent, with the remainder dried and added to the DDG to form DDGS.

Yeast is added to achieve an initial dose of 10-50 million viable yeast cells/ml, and the mixture is fermented for about 40 hours, resulting in less than 1 g/100 ml of sugars. Sugars (also referred to as residual sugars) are a mixture of glucose, di-glucose molecules (i.e. DP2), tri glucose molecules (DP3) and other multiples of the glucose in the solution, with 5% or less of the starch remaining. About 10% (by volume) of the resulting mixture is ethanol, and about 1 to 1.5% of the solution (by weight) is yeast.

The liquid mixture is separated from the yeast cell mass by centrifugation followed by concentration of the liquid using an evaporator to achieve solid content of over 70% typical for molasses type products.

### Example 2

Example 2 describes a high residual sugar ethanol production process according to one embodiment of the invention. Using a batch-fed ethanol wet mill, about 19-23% of each batch is starch in gelatinized slurry. No backset is diverted to the corn steep liquor.

The fermented mixture with the ethanol is then sent to the beer still to remove the ethanol. The residual mixture commonly known as still bottoms are then send to the decanting centrifuge to remove to produce a yeast paste and a dilute sugar solution. The yeast paste is dried on a surface drum dryer and the distillers sugars are evaporated into distiller's molasses.

### Example 3

Example 3 describes the application of the embodiment described in Example 2 to a modified corn dry milling ethanol process that incorporates a fiber and a germ removal step. In one process scenario, whole corn kernels are cleaned and ground and slurried in water and heated to gelatinize the starch at temperatures in the range of 60-80° C. at a pH of 5.5 or higher. Starch liquefaction can then be carried out by adding a thermostable bacterial alpha amylase and the slurry heated further to 105° C. This is followed by cooling with additional alpha added to insure that the starch is liquefied.

The pH of the liquefied starch is adjusted to a pH of about 4.5 and the slurry cooled to 60° C. Once cooled to 60° C., a fungal glucoamylase is added to saccharify the starch to a saccharification liquor that is composed primarily of glucose/maltose/higher sugars. The slurry is then centrifuged to remove the less dense germ layer and/or filtered or decanted to remove the fiber.

The degermed fiber free saccharification liquor is used to produce fuel ethanol. In an alternate process, the whole corn kernels are tempered at temperatures in the range of 30-60 C, and the tempered corn ground and germ and fiber separated with the recovery of an enriched endosperm fraction that consists primarily of starch. The starch fraction is then gelatinized, liquefied and saccharified prior to use at an ethanol producing facility.

Patents, patent applications, publications, scientific articles, books, and other documents and materials referenced or mentioned herein are indicative of the levels of skill of those skilled in the art to which the inventions pertain, as of the date each publication was written, and all are incorporated by reference as if fully rewritten herein. Inclusion of a document in this specification is not an admission that the document represents prior invention or is prior art for any purpose.

The terms and expressions employed herein have been used as terms of description and not of limitation, and there is no intention in the use of such terms and expressions, or any portions thereof, to exclude any equivalents now know or later developed, whether or not such equivalents are set forth or shown or described herein or whether or not such equivalents are viewed as predictable, but it is recognized that various modifications are within the scope of the invention claimed, whether or not those claims issued with or without alteration or amendment for any reason. Thus, it shall be understood that, although the present invention has been specifically disclosed by preferred embodiments and optional features, modifications and variations of the inventions embodied therein or herein disclosed can be resorted to by those skilled in the art, and such modifications and variations are considered to be within the scope of the inventions disclosed and claimed herein.

Specific methods and compositions described herein are representative of preferred embodiments and are exemplary and not intended as limitations on the scope of the invention. Other objects, aspects, and embodiments will occur to those skilled in the art upon consideration of this specification, and are encompassed within the spirit of the invention as defined by the scope of the claims. Where examples are given, the description shall be construed to include but not to be limited to only those examples.

It will be readily apparent to one skilled in the art that varying substitutions and modifications may be made to the invention disclosed herein without departing from the scope and spirit of the invention, and from the description of the inventions, including those illustratively set forth herein, it is manifest that various modifications and equivalents can be used to implement the concepts of the present invention without departing from its scope. A person of ordinary skill in the art will recognize that changes can be made in form and detail without departing from the spirit and the scope of the invention. The described embodiments are to be considered in all respects as illustrative and not restrictive. Thus, for example, additional embodiments are within the scope of the invention and within the following claims.

We claim:

1. A method of manufacturing an animal feed supplement, consisting essentially of:
(a) fermenting a carbohydrate source to produce a fermentation mixture comprising alcohol, water, yeast, fiber, and sugar, wherein said sugar is present in an amount of at least 1 g/100 ml of fermentation mixture;
(b) separating said fermentation mixture to produce a product mixture comprising ethanol and water and a whole stillage comprising water, yeast, fiber, protein and sugar;
(c) separating said whole stillage into a thin stillage comprising water, sugar, from yeast and a wet grain component comprising water and fiber fraction;
(e) condensing said mixture of water and sugar to produce an animal feed.

2. An animal feed supplement produced by the method of claim 1.

3. The method of claim 1, wherein the sugar comprises mono-, di-, tri-saccharides and higher soluble sugars.

4. The method of claim 1, wherein said sugar is present in said fermentation mixture in an amount greater than 1 g/100 ml and less than 9 g/100 ml.

5. The method of claim 4, wherein said sugar is present in said fermentation mixture in an amount greater than 5 g/100 ml and less than 8 g/100 ml.

6. The method of claim 1, wherein the yeast is removed by decanting centrifuge.

7. The method of claim 4, wherein said sugar is present in said fermentation mixture in an amount greater than 1 g/100 ml and less than 4 g/100 ml.

8. The method of claim 5, wherein said sugar is present in said fermentation mixture in an amount greater than 2 g/100 ml and less than 3 g/100 ml.

9. A method of increasing the rate of ethanol production, consisting essentially of fermenting a carbohydrate source to produce a fermentation mixture comprising alcohol, water, yeast, fiber, and sugar, wherein said sugar is present in an amount of at least 1 g/100 ml of fermentation mixture.
